(19) United States
(12) Patent Application Publication
(10) Pub. No.: US 2005/0155950 A1
(43) Pub. Date: Jul. 21, 2005

(54) Method of forming a micro pattern on a substrate

(75) Inventors: Yi Ju Su, Hsinchu (TW); Da Wei Lin, Hsinchu (TW)

Correspondence Address: OSTROLENK FABER GERB & SOFFEN, 1180 AVENUE OF THE AMERICAS, NEW YORK, NY, 100368403, US

(73) Assignee: Macronix International Co., Ltd.

(21) Appl. No.: 10/761,525

(22) Filed: Jan. 20, 2004

(51) Int. Cl. C23F 1/00; B44C 1/22; C03C 15/00; C03C 25/68

(52) U.S. Cl. 216/41

(57) ABSTRACT

In a method of forming a micro pattern on a substrate, the micro pattern is predetermined to be formed in a first area of the substrate and not to be formed in a second area of the substrate spaced apart from the first area. A first shielding layer is formed on a surface of the substrate, and is configured to cover the second area and to expose the first area. A second shielding layer is formed on the surface of the substrate, is superimposed on the first shielding layer, and is configured to expose the first area of the substrate, and a portion of the first shielding layer. The first area of the substrate exposed from the second shielding layer is etched to form the micro pattern. The second shielding layer is then removed from the surface of the substrate and the first shielding layer. Finally, the first shielding layer is removed from the surface of the substrate.

### BACKGROUND OF THE INVENTION

1. Field of the Invention

The invention relates to a method of forming a micro pattern on a substrate.

2. Description of the Related Art

Micropattern formation is a basic process in forming an integrated circuit, and involves forming of a micro pattern on a substrate, such as a silicon wafer, by means of photolithography and etching techniques.

Referring to FIGS. 1a to 1d, in an ideal fabrication process for forming a micro pattern on a substrate 200, a photoresist layer 21 is initially formed on the substrate 200. Subsequently, an image corresponding to an image pattern of a predetermined photo mask (not shown) is formed on the photoresist layer 21 after exposure and development processes, as shown in FIG. 1a. Then, the photoresist layer 21 is etched to result in a shielding layer 22 that exposes a portion of the substrate 200 corresponding to the micro pattern 300, as shown in FIG. 1b. Thereafter, the portion of the substrate 200 exposed from the shielding layer 22 is etched to form the micro pattern 300, as shown in FIG. 1c. Finally, the shielding layer 22 is removed from the substrate 200 by etching, as shown in FIG. 1d.

Referring to FIGS. 2 to 4, in a conventional method of forming a micro pattern 300′ on a substrate 200′, during the exposure process for forming an image 211 on a photoresist layer 21, which is formed on the substrate 200′, an undesired image 212 is formed on the photoresist layer 21 as a result of scattering of projected light through a photo mask (M), as shown in FIG. 2. Thus, when the photoresist layer 21 is etched to result in the shielding layer 22′, as shown in FIG. 3, it is noted that the shielding layer 22′ exposes a first area 201′ of the substrate 200′ that is predetermined to be formed with the micro pattern 300′, and a second area 202′ of the substrate 200′ that should not be formed with the micro pattern. Hence, when the substrate 200′ is etched such that the micro pattern 300′ is formed, an undesired micro pattern 400 is also formed since the second area 202′ is not shielded, as shown in FIG. 4.

Even though the prior art has contemplated forming the photo mask 3 (see FIG. 5) used in micro pattern formation with opposite scattering bars 31 at the periphery of the image pattern for reducing light scattering, undesired micro patterns 400′ are still unavoidably formed on the substrate 200′ according to the conventional method, as shown in FIG. 6.

### SUMMARY OF THE INVENTION

Therefore, the object of the present invention is to provide a method of forming a micro pattern on a substrate that can eliminate the aforesaid drawbacks of the prior art.

According to the present invention, there is provided a method of forming a micro pattern on a substrate. The substrate has a surface with a first area, and a second area spaced apart from the first area. The micropattern is predetermined to be formed in the first area and not to be formed in the second area. The method comprises the steps of:

(a) forming a first shielding layer on the surface of the substrate, the first shielding layer being configured to cover the second area and to expose the first area;

(b) forming a second shielding layer on the surface of the substrate, the second shielding layer being superimposed on the first shielding layer, and being configured to expose the first area of the substrate, and a portion of the first shielding layer;

(c) etching the first area of the substrate exposed from the second shielding layer to form the micro pattern;

(d) removing the second shielding layer from the surface of the substrate and the first shielding layer; and

(e) removing the first shielding layer from the surface of the substrate.

### BRIEF DESCRIPTION OF THE DRAWINGS

Other features and advantages of the present invention will become apparent in the following detailed description of the preferred embodiment with reference to the accompanying drawings, of which:

FIGS. 1a to 1d illustrate consecutive steps of an ideal fabrication process for forming a micro pattern on a substrate;

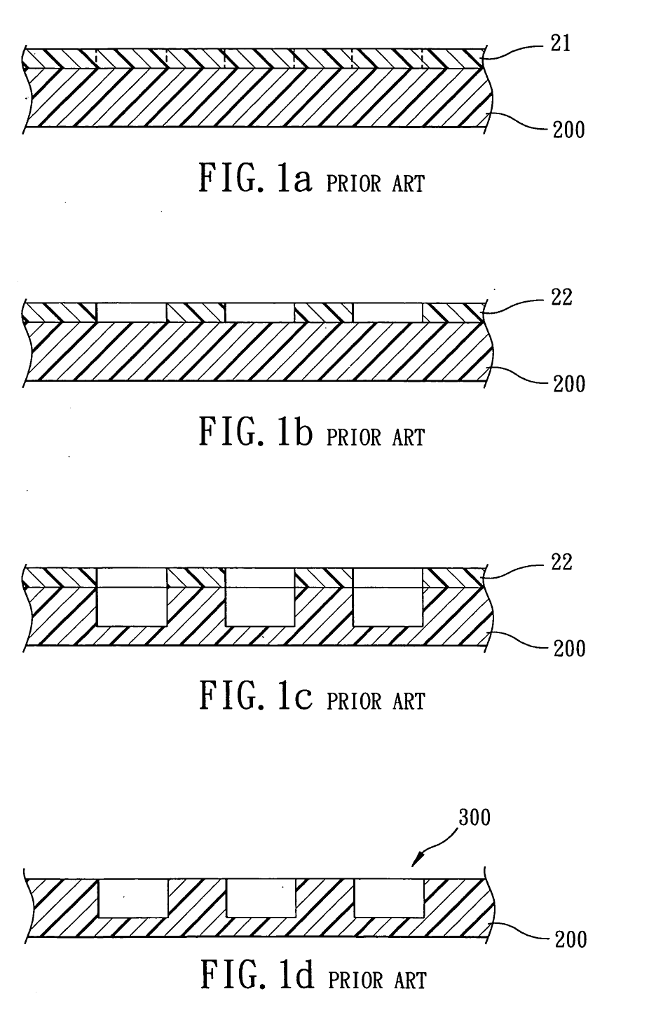

FIGS. 2 to 4 illustrate fabrication processes according to a conventional method of forming a micro pattern on a substrate;

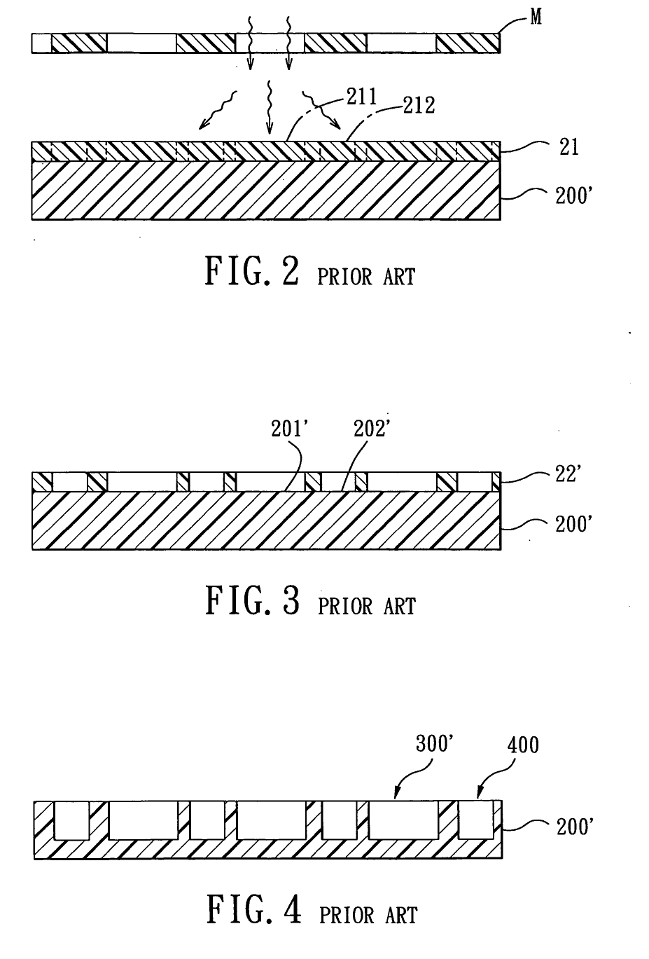

FIG. 5 is a fragmentary schematic view showing a photo mask used in the conventional method;

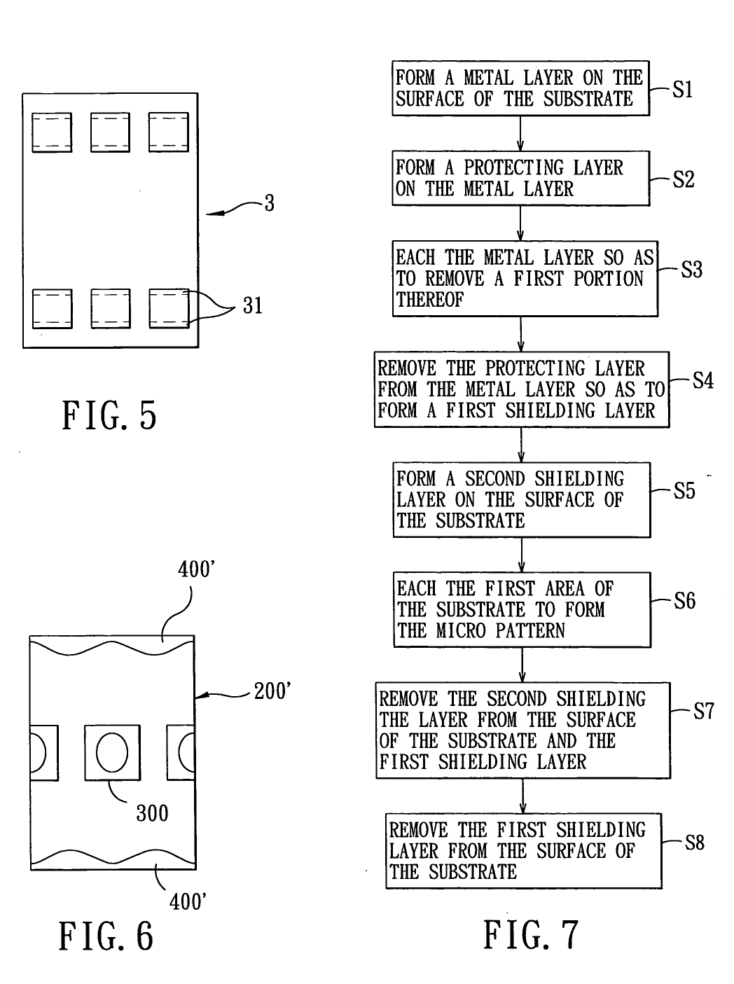

FIG. 6 is a fragmentary schematic view showing micro patterns formed in the substrate according to the conventional method;

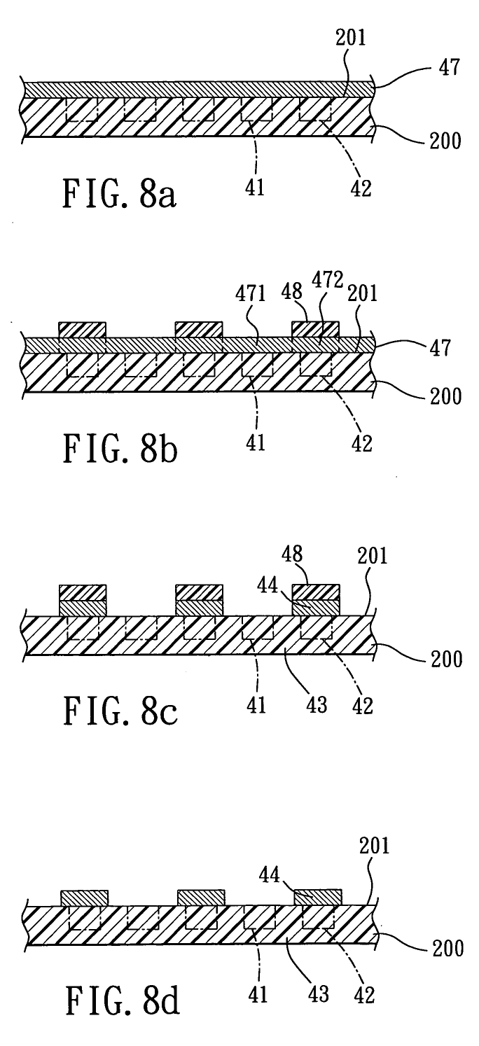

FIG. 7 is a flow chart illustrating consecutive steps of the preferred embodiment of a method of forming a micro pattern on a substrate according to this invention; and

FIG. 8a to 8i illustrate fabrication processes according to the preferred embodiment.

### DETAILED DESCRIPTION OF THE PREFERRED EMBODIMENT

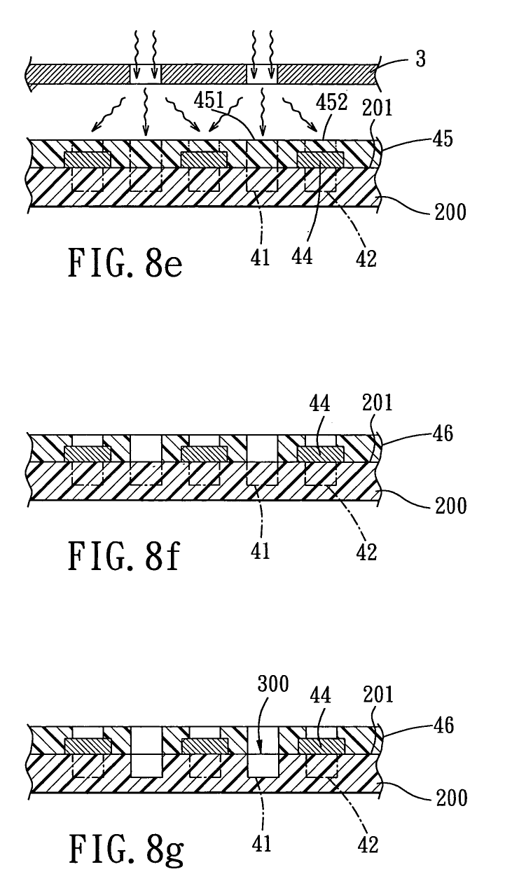

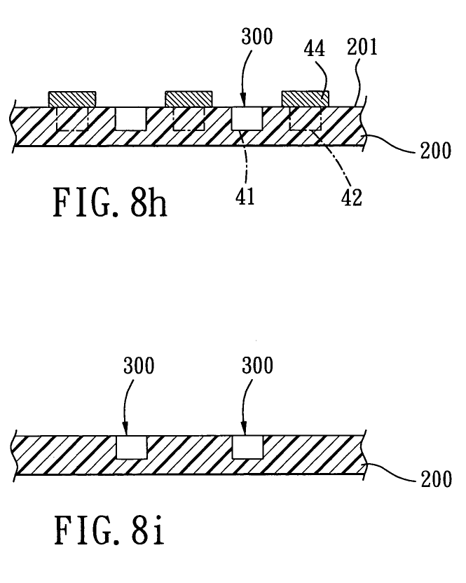

FIG. 7 illustrates consecutive steps of the preferred embodiment of a method of forming a micro pattern 300 on a substrate 200 (see FIG. 8i) according to the present invention. As shown in FIG. 8a, the substrate 200, such as a silicon wafer, has a surface 201 with a first area 41, and a second area 42 spaced apart from the first area 41. The micro pattern 300 is predetermined to be formed in the first area 41 and not to be formed in the second area 42.

In step S1, a metal layer 47, such as a chromium layer, is formed on the surface 201 of the substrate 200, as shown in FIG. 8a. In step S2, a protecting layer 48 is formed on the metal layer 47. The protecting layer 48, such as a photoresist layer, is configured to expose a first portion 471 of the metal layer 47 corresponding to the first area 41 of the substrate 200 and to cover a second portion 472 of the metal layer 47 corresponding to the second area 42 of the substrate 200 through a known photolithography process with the use of a photo mask (not shown) , as shown in FIG. 8b. In step S3, the metal layer 47 is etched so as to remove the first portion 471 thereof, as shown in FIG. 8c. In step S4, the protecting layer 48 is removed from the metal layer 47 so as to form a first shielding layer 44 (i.e., the second portion 201 of the metal layer 47). As such, the first shielding layer 44, which is a hard mask, is thus formed on the surface 201 of the substrate 200 and is configured to cover the second area 42 and to expose the first area 41. In step S5, a photoresist layer 45 formed on the surface 201 of the substrate 200 and superimposed on the first shielding layer 44 is subjected to conventional photolithography processing with the use of a predetermined photo mask 3 such that the photoresist layer 45 is patterned to form a desired image pattern 451, and an undesired image pattern 452 as a result of scattering of projected light, as shown in FIG. 8e. The photoresist layer 45 is then etched so as to form a second shielding layer 46 that is configured to expose the first area of the substrate 41 and a portion of the first shielding layer 44, as shown in FIG. 8f. In step S6, the first area 41 of the substrate 200 is etched to form the micro pattern 300, as shown in FIG. 8g. It is noted that, due to the presence of the first shielding layer 44, it is impossible to etch the portion of the substrate 200 covered by the first shielding layer 44. Therefore, precise micro pattern formation is possible in the method of the present invention. In step S7, the second shielding layer 46 is removed from the surface 201 of the substrate 200 and the first shielding layer 44, as shown in FIG. 8h. In step S8, the first shielding layer 44 is removed from the surface 201 of the substrate 200, as shown in FIG. 8i.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A method of forming a micro pattern on a substrate, the substrate having a surface with a first area, and a second area spaced apart from the first area,. the micro pattern being predetermined to be formed in the first area and not to be formed in the second area, said method comprising the steps of:
(a) forming a first shielding layer on the surface of the substrate, the first shielding layer being configured to cover the second area and to expose the first area;
(b) forming a second shielding layer on the surface of the substrate, the second shielding layer being superimposed on the first shielding layer, and being configured to expose the first area of the substrate, and a portion of the first shielding layer;
(c) etching the first area of the substrate exposed from the second shielding layer to form the micro pattern;
(d) removing the second shielding layer from the surface of the substrate and the first shielding layer; and
(e) removing the first shielding layer from the surface of the substrate.

2. The method as claimed in claim 1, wherein step (a) includes the sub-steps of:
(a-1) forming a metal layer on the surface of the substrate;
(a-2) forming a protecting layer on the metal layer, the protecting layer being configured to expose a first portion of the metal layer corresponding to the first area and to cover a second portion of the metal layer corresponding to the second area;
(a-3) etching the metal layer so as to remove the first portion thereof; and
(a-4) removing the protecting layer from the metal layer so as to form the first shielding layer, the second portion of the metal layer serving as the first shielding layer.

3. The method as claimed in claim 1, wherein the first shielding layer is made of a material different from the substrate, and the second shielding layer is made of a material different from the substrate and the first shielding layer.

4. The method as claimed in claim 3, wherein the first shielding layer is a hard mask.

5. The method as claimed in claim 4, wherein the first shielding layer is made of chromium.

6. The method as claimed in claim 3, wherein the second shielding layer is a photoresist layer.
